(19) United States
(12) Patent Application Publication
(10) Pub. No.: US 2005/0155043 A1
(43) Pub. Date: Jul. 14, 2005

(54) Human-machine interface system and method for remotely monitoring and controlling a machine

(76) Inventors: Kurt S. Schulz, Cincinnati, OH (US); Corey O'Brien, Chicago, IL (US); Alex Rozenson, Liberty Township, OH (US); Mark P. Smith, Cincinnati, OH (US)

Correspondence Address: DON W. BULSON, 1621 EUCLID AVENUE / 19TH FLOOR, RENNER, OTTO, BOISSELLE & SKLAR, LLP, CLEVELAND, OH, 44115, US

(21) Appl. No.: 10/755,170

(22) Filed: Jan. 8, 2004

(51) Int. Cl. G06F 9/44; G09G 5/00; G05B 23/02; G05B 15/00; G06F 15/16

(52) U.S. Cl. 719/328; 345/665; 340/3.1; 700/83; 709/204

(57) ABSTRACT

A system and method for providing a graphical human-machine interface (“HMI”) for a machine having controllable parts. The system and method implement an HMI in real time using a standard browser over a network. The system and method permits remote users to make modifications to the HMI and to the control status of the machine. Any subsequent modifications are transmitted to the machine and all remote users in real time. Thus, the system and method allow a remote user to effectively monitor and control machines and processes without the need for the operator to be physically present at the location where the machine or process is located or being performed.

### BACKGROUND OF THE INVENTION

1. Technical Field

The present invention relates generally to the field of monitoring and controlling machines and processes with a human-machine interface, particularly, to a system and method for implementing a human-machine interface in real-time to monitor and control machines and processes locally and remotely, with no apparent difference to the user other than possibly update time of the human-machine interface.

2. Description of the Related Art

Within the past thirty years computer technology has dramatically altered the course of industry, residential lifestyles, the military and so forth. Prior to the development of the computer, manufacturers implemented manual assembly lines to manufacture an article of commerce. For example, the moving assembly line used by Henry Ford to manufacture automobiles consisted literally of a line of workers physically adding one component to each automobile as it moved past them on the assembly line. Today, many modern manufacturers rely predominantly on computer controlled automation to manufacture their goods. In many instances, it is not uncommon for an entire production line to be completely automated. In such instances, personnel are typically used only to monitor and control production devices from computers or processes in a control room located within the manufacturing plant.

With this capability, manufacturers and others quickly moved to centralize the control and monitoring of all or a portion of their plants in one location. Turning to FIG. 1, an exemplary prior art system is shown. The machine 10 has parts or functions that are capable of being monitored and/or controlled by a controller 12. The controller 12 is typically a programmable logic controller. The controller 12 is interfaced directly to a personal computer 14 having a modem 16. The personal computer 14 typically has software resident for the user to monitor and control the machine 10. The modem 16 is typically connected to a dedicated telephone line 18 to transmit and receive information to a control facility 18, thereby allowing remote monitoring and controlling of machine 10 by a remote control facility 20.

With the advent of high speed data communication networks, such as the Internet, manufactures migrated from dedicated telephone lines and host computers to a client-server based architecture to remotely monitor and control machines and processes. FIG. 2 shows an exemplary client-server system. Machine 10, controller 12, and computer (client) 14 may be the same as discussed above with reference to FIG. 1. Instead of using a modem, client-server systems typically use a network card 22 to communicate data to and from the machine 10. The network card 22 connects the computer 14 to the server 26 via a computer network 24, typically Ethernet. The information is conveyed from the server 26 through a wide area network 28 (e.g., the Internet) and to the remote control facility 20 via a high speed transmission line 30, typically T1 or higher. However, the conversion to an Internet based monitoring and control solution resulted in new problems related to bandwidth, displaying information on open systems, and the ability to timely exchange data over the Internet.

The World Wide Web (the “web”) is a subset of the Internet particularly germane to industrial monitor and control applications. The web organizes information in documents using hyper media. Each web document (“web page”) typically contains information via hyperlinks. Such information typically takes the form of text or embedded references to images, audio and video clips, or other documents. Web documents are accessible over the Internet through various computer applications called web browsers. Examples of browsers include: Netscape Navigator and Microsoft Internet Explorer, both which run on personal computers; as well as Pixo and Neomar, both of which operate on wireless handheld devices, such as personal digital assistants (“PDA”) or cellular phones. In an effort to make web pages uniformly readable by all types of browsers, the web has evolved such that web pages are typically specified in terms of content and format by one of several hardware and browser independent page description languages that are well known in the art. Some of these languages include: markup languages such as HTML, SHML, XML and XSL, and scripting languages such as JavaScript.

The Internet is often utilized for multimedia information retrieval. To access the Internet, computers interact with web servers using communication protocols that provide access to multimedia information (e.g., text, graphics, images, sound, video, etc.). Examples of such protocols include: Hypertext Transfer Protocol (“HTTP”) and Wireless Application Protocol (“WAP”). In the Internet paradigm, information is accessible at addresses, each of which is identified by a Uniform Resource Locator (“URL”). When using a web browser to access the Internet, a browser makes a request to the server on which the information or files is located (the identity of the server is contained in the URL) and, in return, the server returns to the client the desired information (e.g., a document or other object requested). The client's browser then interprets the received information and performs an appropriate function. Such function might be to display the returned information, execute a script, execute a plug-in, or store a file to a storage device at the client.

As previously discussed, information that is accessible via the Internet may be formatted in a multitude of languages. One of the most common page description languages is Hypertext Markup Language (“HTML”). HTML provides basic document formatting and allows programmers to specify “links” from one file to another. Other examples of markup languages include Extensible HyperText Markup Language (“xHTML”), Handheld Device Markup Language (“HDML”), Wireless Markup Language (“WML”), Extensible Markup Language (“XML”). Generally, when a browser accesses an HTML file, a web page is displayed.

To retrieve information from a specified URL address, browsers send requests to web servers. In handling user requests, servers employ several methods. One such method of handling browser requests is by way of static resources. In handling a request for a static resource, a server simply loads the requested resource, such as a HTML file, and returns it to the user. Another method of handling requests is to dynamically generate resources through a Common Gateway Interface (“CGI”) implementation. In handling a request involving CGI technology, scripts are used to dynamically build the requested resource, (e.g. dynamically generated resource), such as dynamically generated HTML. While more flexible than static resources, CGI handling has generally been considered slow and expensive in terms of computing and networking resources. In an attempt to solve this problem, Web Application Servers (“WAS”) were developed. Web Application Servers generally utilize advanced caching, employ resident scripts, and have advanced monitoring multithreading capability, allowing them to process incoming requests faster and more reliably.

Even with improvements in the manner in which servers handle browser requests, transferring real-time information over the Internet remains problematic. As explained in more detail below, the difficulty arises from bandwidth limitations and the ability to push information uploaded from a remote user and provides the information to other remote users in a time sensitive manner. Current web applications typically require reloading an entire web page. This problem is heightened by the fact that, in many instances, a web page designer has included many graphics to enable the viewer to more easily understand the information presented. The need for detailed graphics is particularly important for the remote user in monitoring and controlling industrial processes, many of which may implicate significant safety and cost issues.

Currently, a human-machine interface (“HMI”) can be used for monitoring and controlling various industrial machines, production lines and continuous processes. For example, an HMI can be the software and/or hardware systems that interface between patent application machine and the machine's human operator. HMI technology allows plant operators the ability to control plant equipment functions from personal computer platforms. User input devices, such as a computer mouse or keyboard, are typically used to control the operation and functions of the machine or process. HMI applications generally utilize a great deal of graphics. In many instances, the HMI developer attempts to emulate the entire physical machine or manufacturing process on a computer display. The ultimate goal for the HMI developer is to design an interface that provides a machine operator with the ability for remote and local monitoring and control, as transparently as possible (i.e., providing the user with the same graphical user interface and functionality regardless of whether the user is monitoring or operating the machine or process locally or remotely). In addition to displaying the visual data associated with a process, HMI applications typically provide a mechanism by way of visual and audio alarms to alert a remote plant operator of potential manufacturing or other problems associated with the process.

Existing HMI applications typically render screens using graphical drawing interfaces provided by, and integral to, the operating system. An example of this is the GDI (graphics drive interface) program interface provided by the Windows operating system. The interface is used to create graphic screens using a combination of vector-based and raster-based objects. While this method works well for low fidelity graphic screens viewed locally, it does not provide the features necessary for high quality, realistic rendering of objects typically desired by HMI application users.

Another significant problem with this approach is that it does not permit the application screens to be transmitted efficiently over a network, such as the Internet, for display in a web browser, and with sufficient performance to accurately represent the real time data from the control devices. Web browsers typically expect data from the server to be in HTML format, with graphic content transmitted as raster-based images in GIF or JPG formats. Web servers have great difficulty translating dynamic screens that are drawn using GDI into these formats for projecting over the Internet into a standard web browser. As a result, HMI system performance is usually very poor.

There is a strong need in the art for an HMI system and method that operates efficiently over the Internet in a standard web browser that is capable of displaying information in real-time.

### SUMMARY OF THE INVENTION

The present invention is directed a system and method for implementing a human-machine interface in real-time to monitor and control machines and processes locally and remotely, with no apparent difference to the user other than possibly update time of the human-machine interface.

One aspect of the present invention is directed to a system for providing a graphical human-machine interface for a machine having a controllable part, the system including: a controller communicatively coupled to an associated machine having a controllable part; a server communicatively coupled to the controller to receive information relating to properties of the associated machine; at least one client communicatively coupled to the server; wherein the client includes a display and a web browser for displaying information on the display, wherein the server transmits a predetermined animation of the properties of the machine to the client, the predetermined animation including real time information relating to the properties, the real time information being introduced into the animation by a data module executed by the server that updates data object values in the animation.

Another aspect of the present invention is directed to a method for providing a graphical human-machine interface for a machine having a plurality of controllable parts, the method including: communicatively coupling a server to a controller of an associated machine having a controllable part to receive information relative to the properties of the associated machine; communicatively coupling at least one client to the server; wherein the client includes a display and a web browser for displaying information on the display; and transmitting a predetermined animation of the properties of the associated machine from the server to the client, the predetermined animation including real time information relating to the properties, the real time information being introduced in to the animation by a data module executed by the server that updates data object values in the animation.

Another aspect of the present invention is directed to a method for providing a graphical human-machine interface for a machine having a controllable part, the method including: requesting access to a web page from a server containing a human-machine interface for the machine for display on a display associated with a client; receiving a predetermined animation of properties of the associated machine, the predetermined animation including real time information relating to the properties and rendering the predetermined animation; receiving a user input to modify at least one assigned property of the predetermined animation; re-rendering a graphical object associated with the modified property; and communicating the modification to the server.

Another aspect of the present invention is directed to a method of providing a graphical human-machine interface for a machine having a controllable part, including: receiving and rendering for display a predefined animation containing graphical objects from a server, each graphical object having an assigned property value and is associated with a property of the machine; receiving a push delivered change to at least one assigned property value corresponding to a change in property of the machine and re-rendering a graphical object associated with the changed property value to update to the animation; receiving a signal associated with a user action from a user input device; and transmitting a command corresponding to the signal from the user input device to the server.

Another aspect of the present invention is directed to a method for providing a graphical human-machine interface for a machine having a controllable part, including: receiving a request from a client for access to a web page with the graphical human-machine interface for the machine, the web page including a predetermined animation of properties of the associated machine; transmitting the web page to the client; and updating the predetermined animation to include real time information relating to the properties, the real time information being introduced in to the animation by a data module executed by the server that transmits updated data object values for graphical objects of the animation to the client.

Another aspect of the present invention is to a method of changing an object value in a predefined animation, including: transmitting the predefined animation to an interpreter for rendering, the predefined animation containing graphical objects each with an assigned property value; receiving a signal containing information relating to an update for one of the graphical objects; and push delivering a new property value for the one of the graphical objects to the interpreter for re-rendering the one of the graphical objects.

Another aspect of the present invention is to a method of changing an object value in a predefined animation, including: receiving the predefined animation from a server and rendering the predefined animation with an interpreter executed by a client, the predefined animation containing graphical objects each with an assigned property value; and receiving a push delivered new property value for the one of the graphical objects with the interpreter and re-rendering the one of the graphical objects.

### BRIEF DESCRIPTION OF THE DRAWINGS

FIG. 1 is a block diagram of a conventional HMI system with dedicated telephone lines.

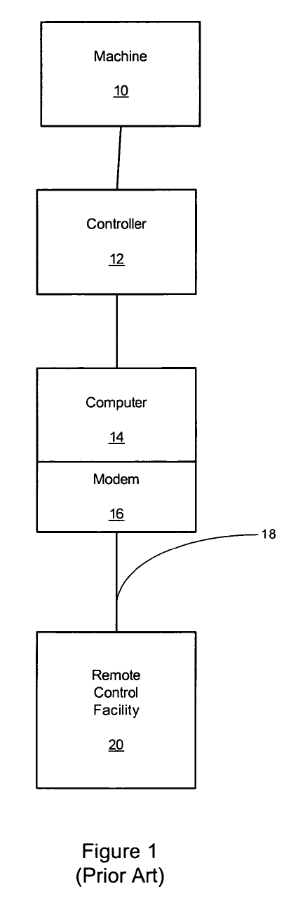

FIG. 2 is a block diagram of a conventional HMI system with a client-server architecture.

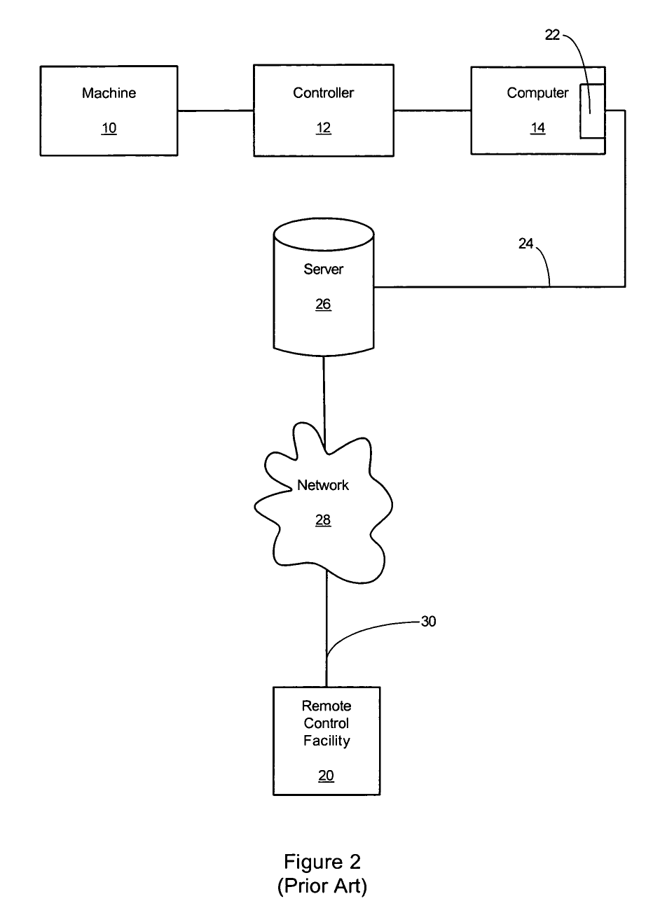

FIG. 3 is a block diagram of an embodiment of an HMI system according to the present invention.

FIG. 4 is an example screen shot display by the HMI system of FIG. 3.

FIG. 5 is a block diagram of another embodiment of an HMI system according to the present invention.

FIG. 6 is a block diagram of a data path according to the present invention.

FIG. 7 is a block diagram of another data path according to the present invention.

### DETAILED DESCRIPTION OF THE INVENTION

The following description is merely exemplary in nature and is in no way intended to limit the scope of the invention as defined by the claims appended hereto. The phrase “real time”, as used herein, is machine dependent and requires only that information be received or transmitted in a timely manner to provide the ability for sufficient monitoring or controlling of a particular machine. As used herein, “real time” is used without regard to network latency, propagation delay, processing delay and so forth.

In order to perform the real time data exchange described herein, an interpreter and development tool are used. A suitable animation interpreter is Macromedia's Flash player and a suitable animation development tool is Flash MX, also available from Macromedia. Flash player and Flash MX are tools for web developers to create vector images (or graphics) and movies (collectively referred to herein as animations) for display on web browsers. The animation may include video information captured by a camera and/or drawn illustrations, including moving and still images. Vector images generally have much smaller file sizes than bitmapped images, such as GIFs and JPEGs, and therefore the corresponding files are much more compact and can be efficiently transmitted over WANs, like the Internet. Unlike bitmapped images that are optimized for a single resolution, vector images can adapt to multiple display sizes and resolution. Once the vector images are received by the web browser, the web browser recognizes that a Flash file (SWF file format) has been received and invokes the client-side Flash player to interpret the file.

Flash MX is an authoring tool to make Flash animations that are then interpreted by the Flash player and displayed in a web browser. Flash MX provides designers with a scripting language called Actionscript for designing graphic content and animation via scripting. Macromedia's Flash player does not provide an external object model for users to write a script in a web page to directly access objects that exist in a Flash animation. The functionality of Flash player and Flash MX are described in the following publications: Macromedia's Flash White Paper, Flash Remoting MX: A Responsive Client-Server Architecture for the Web and U.S. Pat. No. 5,592,602 that are incorporated herein by reference in their entireties as if fully rewritten herein. One of ordinary skill in the art will appreciate that while the present invention is being described with respect to Macromedia Inc.'s Flash player and Flash MX, the use of these applications is exemplary and is in no way intended to limit the scope of the invention (e.g., the present invention could also be implemented using scalable vector graphics (SVG) over a Java platform).

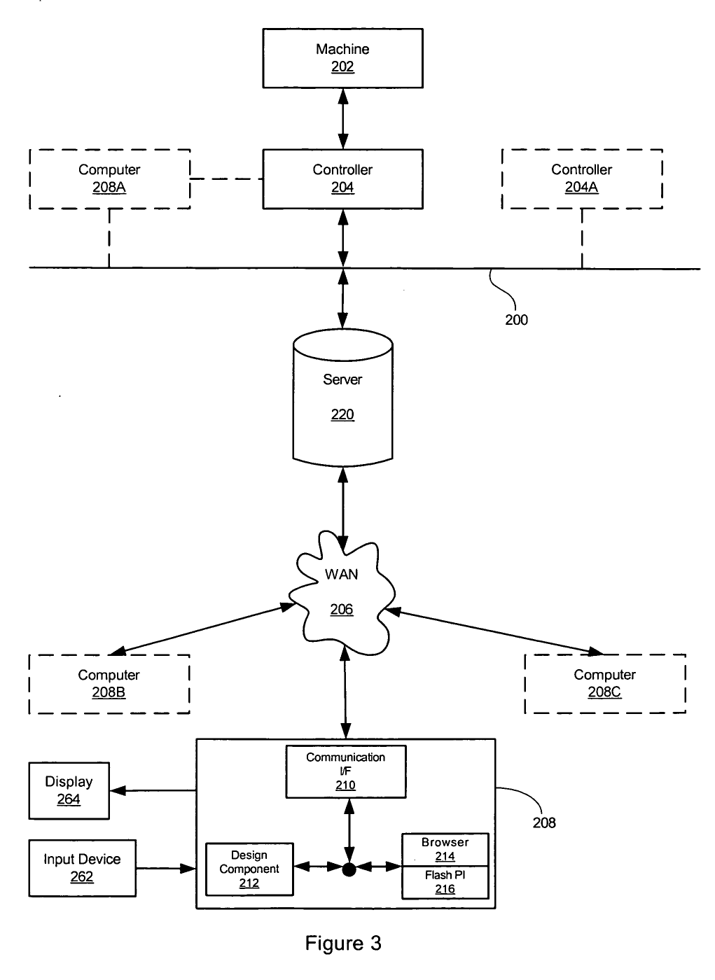

Turning now to FIG. 3, an embodiment of an HMI system is shown. The system comprises a data transport network 200 illustrative of a local area network (“LAN”) and/or wide area network (“WAN”) environment, such as a packet-switched TCP/IP-based global communication network. The network 200 is suitably any network and may be comprised of physical layers and transport layers, as illustrated by a myriad of conventional data transport mechanisms like Ethernet, Token-Ring™, IEEE 802.11 standard, Wi-Fi, or other wire-based or wireless data communication mechanisms as will be apparent to one of ordinary skill in the art.

Machine 202 is connected to the network 200 through a controller 204 (also referred to herein as a machine control device). As shown in FIG. 3, machine 202 and controller 204 communicate directly with one another. It will be appreciated that the machine 202 and controller 204 can also be configured to communicate with each other across the network 200. For example, the controller 204A, illustrated with dashed lines, may communicate with the machine 202 across the network 200 (bypassing controller 204). The machine 202 may be any machine with one or more controllable aspects or parts, such as limit switches, sensors, motor drives, and the like, as will be appreciated by those skilled in the art. As used herein, the term machine is used in its broadest sense and suitably includes self-contained devices (e.g., an automobile, a robotic arm, a printer, a surgical apparatus and so forth) and systems that include multiple devices (e.g. a steel producing factory, a newspaper printing facility, an assembly line, a semiconductor chip plant, and so forth). Also, the parts of the machine 202 need not be limited to a single location, (e.g., multiple devices or processes distributed throughout a plant or in different geographical locations may comprise the machine 202). It is within the scope of the present invention that the machine 202 may include multiple machines that may communicate via a network, (e.g., a LAN or WAN).

In communication with the machine 202 is the controller 204, which can be any machine control device. The controller 204 may be a programmable logic controller (“PLC”), a PC-based logic controller (“PCLC”), a computer having control software, or the like, including combinations thereof. The controller 204 preferably supports a variety of controller languages (e.g., IEC 61131), is capable of controlling simultaneous tasks, supports local, remote or fieldbus I/O, and utilizes solid-state storage, such as Compact FLASH storage media. It will be appreciated by those skilled in the art that each machine 202 has specific control requirements, and that the specific configuration of the controller 204 is typically machine-dependent.

In addition, the controller 204 typically acts as a slave to the OPC server 250 or an equivalent as described below. The controller 204 may operate as or in conjunction with at least one external server, such as a control server and a web server (e.g., in FIG. 3, the controller 204 operates in conjunction with server 220). While the server 220 and the controller 204 are shown as distinct and separate components or modules, the present invention also encompasses providing the functionality of the server 220 within the controller 204.

The server 220 may run on any operating system including Windows NT, Windows 2000, Windows XP, Windows CE, Unix, Mac OS X and Linux. In one embodiment, the server runs on Windows CE.Net 4.2 (also known as CE.Net) which provides many core system services such as: web server (HTTPD), FTP server, Telnet server, Jscript, VBScript and Bluetooth gateway configurations utilities. Generally, the server 220 receives information from the controller 204 and makes such information available to clients via the WAN 206 upon request. Likewise, the server 220 transmits information from computers 208 to the controller 204. In one embodiment, the server 220 utilizes a modified Simple Object Access Protocol (“SOAP”) to create widely distributed, complex computing environments that run over the Internet using existing Internet infrastructure. SOAP permits applications to communicate directly with each other over the Internet.

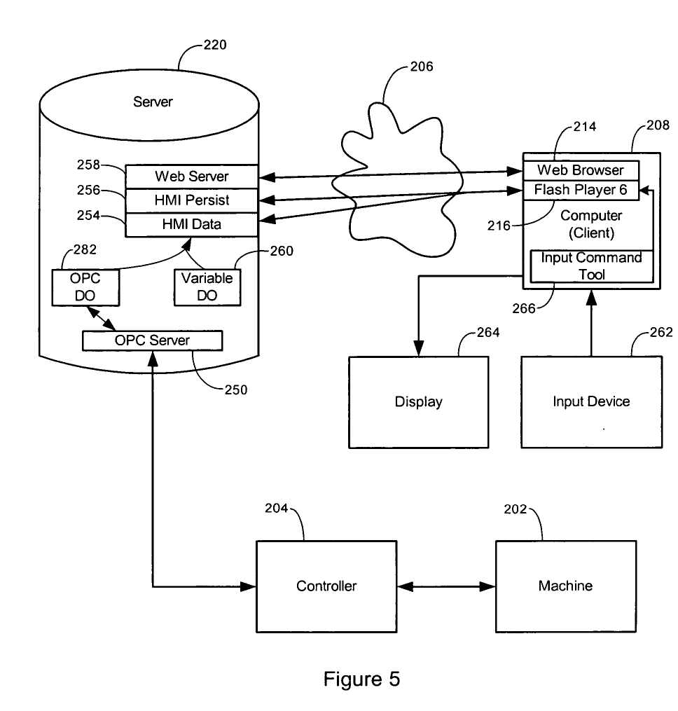

As shown in FIG. 5, the server 220 includes a variety of functional components, including an OPC server 250, an OPC data object 252, an HMI Data 254, an HMI persist module 256, a web server 258, and a variable data object 260. The functionality of each of these components will be discussed below. While each of these elements is pictured discretely, one of ordinary skill in art will appreciate that the precise location of these components and their interconnection is immaterial to the scope of the present invention. Furthermore, while these units are displayed on the server 220, as set forth above, an embodiment of the present invention is for the functionality of the server 220 to be contained within the controller 204. Likewise, any type of network configuration, such as configurations comprising intermediary servers, can be suitably utilized. It should be stressed and understood by those skilled in the art that any configuration of devices comprising a machine 202 and a controller 204 is considered to be within the scope of the present invention whenever information about the machine 202 from the controller 204 is available to a computer 208 (or client) via a WAN 206.

As shown in FIG. 3, in communication with the controller 204 via the WAN 206 is a computer 208 (sometimes referred to herein as a client). In one exemplary environment, the WAN 206 is the Internet. Thus, a data path is formed between computer 208 and machine 202. While the present discussion relates to a single computer 208, it should be understood by one of ordinary skill in the art that this discussion is applicable to a multiple component system, whether any particular computer is physically local or remote in geographic relation or communication to the controller 204, as shown by computers 208A, 208B, and 208C in FIG. 3. The computer 208 is any device capable of allowing a user to communicate with the machine 202 by displaying information received from the controller 204 and/or transmitting data to the controller 204 in response to human input or software related commands. As such, the computer 208 may be a server or client running on any operating system (“OS”), such as Windows NT, Windows 2000, Windows XP, Windows CE, Unix, Linux, Macintosh, PALM or other operating system. Such computer 208 is typically a PC or a wireless handheld device, such as a PDA or a cell phone, all of which comprise a display for displaying graphical objects and means for receiving user input (e.g., keyboard, mouse, touch screen, etc.).

The computer 208 includes hardware and software systems designed to request information or processing of information from servers, such as server 220. The computer 208 suitably includes at least one processor (not shown) for executing instructions, usually in the form of computer readable code, to carry out a specified logic routine. The computer 208 also has memory (not shown) for storing data, software, logic routine instructions, computer programs, files, operating system instructions, and the like. The memory may comprise several devices and includes, for example, volatile and non-volatile memory components.

The computer 208 further includes a communications interface 210 for transmitting and receiving information to other devices (e.g., controller 204 or computers 208A-C) through a network (e.g., the WAN 206). The communications interface is suitably, for example, a modem, network card and/or other type of transceiver. The communications interface 210 enables the computer 208 to send and receive data signals, voice signals, video signals, and the like, as is well known in the art. As one ordinarily skilled in the art will appreciate, multiple communication interfaces 210 can be provided. The communications interface 210 can be configured for coupling to various types of media, such as a satellite transceiver, a coaxial cable, a fiber optic cable, a telephone cable, a network cable, a wireless transceiver, or the like.

As shown in FIG. 5, the computer 208 also has a display 264. Such a display may take many forms, such as a cathode ray tube (“CRT”), a liquid crystal display (“LCD”), a plasma display, an electroluminescent display, or any other visual display. In addition, the computer 208 also includes at least one input device 262, such as a keyboard, a mouse and a microphone, a keypad, a touch pad, a touch screen, a joystick, a digital camera, a scanner, a digital pen, a data card reader (e.g., a smart card reader), and a biometric sensor, etc., as will be appreciated by those skilled in the art.

The computer 208 interacts with a server using a communication protocol (such as Hypertext Transfer Protocol (“HTTP”) and Wireless Application Protocol (“WAP”)) to provide a user with access to multimedia information (e.g., text, graphics, images, sound, video, etc.). As such, the computer 208 suitably comprises a browser 214, such as Netscape Navigator, Microsoft Internet Explorer, Pixo, Neomar, or the like, for making requests to and receiving information from a server, such as a web server. The browser 214 can directly or ostensibly include an interpreter function. A particularly well suited interpreter function is embodied in Flash player software 216 available as a plug-in for common browsers from Macromedia, Inc. The browser 214 with the functionality of the Flash player 216 may also be implemented in proprietary software (e.g., using SVG over a Java platform). As discussed above, the Flash player 216 essentially allows an application to be displayed in a standard web browser, such as web browser 214 with efficiency and uniformity across various display devices.

The computer 208 further includes a design component 212 (as shown in FIG. 3), for providing the developer or operator (with sufficient access rights) with the capability of adding, deleting or modifying any component associated with the human-machine interface (e.g., graphic depictions, text, tools, etc.). The design component 212 is typically computer readable code, whether compiled or interpreted, on a computer readable medium written in any one of a myriad of programming languages currently available. As such, the design component 212 is any piece of prewritten code that defines interfaces that can be called to provide the functionality that the component encapsulates. In one embodiment, the design component 212 is written in Actionscript and is executed by the Flash player. Further, the design component 212 is suitably callable from multiple languages, or from multiple environments, or OS. In addition, the design component 212 may also include a plurality of software modules or components configured to interact with one another and the computer 208 to provide the functionality described herein. Additionally, the design component 212 may comprise computer readable code that is scriptable, or modifiable and executable through scripting, as will be appreciated by those skilled in the art.

The controller 204 functions as a gateway to the machine 202 for purposes of receiving and/or transmitting control and machine status information. Thus, information is transmitted bi-directionally between the machine 202 and the controller 204. Such information suitably comprises: machine status or property information, data transfer information, machine configuration information, error and alarm information, networking information, user information, and the like. The machine 202 transmits information to the controller 204, in turn, the controller 204 transmits the information, to the server 220. The information sent between machine 202 and controller 204 is in a suitable format which depends on the configuration and requirements of machine 202 and controller 204.

The information from the machine 202 received by the controller 204 is then transmitted to the computer 208 via the server 220. In one embodiment, the information is sent via the WAN 206, such as the Internet. However, it is also within the scope of the present invention to send information via a LAN or other data transport network, such as by direct interface between controller 204 and computer 208.

An operator interacts with the computer 208 to effectively monitor and control the machine 202. The HMI solution entails at least two modes, a design mode for creating and modifying an HMI and a run mode for executing the HMI. The design mode makes use of the functionality implemented in the design component 212 along with additional components (e.g., applicant's proprietary software) to allow the HMI developer to customize panels (display screens) to monitor and control any machine or process. Design component 212 provides the HMI developer with a variety of tools to make an efficient and realistic application for the control and monitoring of a particular process. Such tools include graphical objects such as menus, dialog boxes, buttons, graphics, labels, gauges, alarms, counters, sliders, meters, dials, etc. In the design mode, the designer typically uses a set of tools to design and create an animation that can be interpreted (or played) on a client computer. Such predefined animations can embody properties of the machine that are going to be monitored and/or controlled by remote client computers.

The present invention allows a user with a web browser and the Flash player plug-in installed on a computer to access a run time machine and enter into the design mode. In the past, HMI applications were designed to have two separate systems, one for designing the HMI application and one for executing the application. In practice, this implementation presented a variety of problems to both the HMI application developer and the HMI operator. The present invention makes use of the Flash movie (or animation) and provides the user with access to the run-time platform with the ability to access both the design and run modes by simply connecting a standard browser that includes the Flash player plug-in available on to a run-time machine. In particular, since the resultant Flash animation (or movie) contains both design and runtime components, the present invention allows a user having only a web browser and the Flash player plug-in to enter the design mode from a run-time machine.

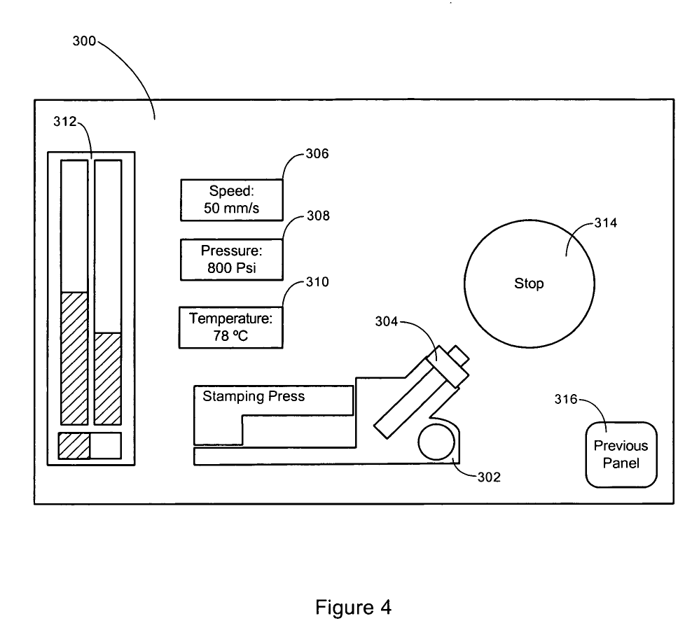

Turning now to FIG. 4, shown is a representation of an HMI “panel” (or screen) viewable on a standard web browser, such as browser 214. For example, the HMI panel 300 emulates a “real world” stamping press. The stamping press is depicted by the stamping press representation 302. A piston 304 of the stamping press representation 302 can be presented in an animated type fashion to move in direct correlation and in real time to the physical machine being emulated. In addition, the HMI panel 300 provides the ability to monitor actual physical parameters associated with the stamping process in real time, such as speed 306, pressure 308, and temperature 310. As shown in FIG. 4, the physical parameters may be illustrated numerically (e.g., speed 306, pressure 308 and temperature 310). In addition, the physical parameters may also be represented with an analog meter 312 (e.g., moving bar graphs), indicator lights (not shown) or a gauge (not shown). Furthermore, an application may include multiple panels (e.g., one panel emulating the physical machine and another panel summarizing results). A button 316 is one way to implement multi-panel functionality by providing a link to another panel. Accordingly, the HMI developer is provided with a variety of tools to design graphical objects that match the physical controls, indicators status and/or status located on or associated with the machine 202 and/or the controller 204.

As discussed above, the graphical objects also consist of representations of parts or aspects of the machine 202. The controls are interactive in that once changed, activated or deactivated, the graphical object is displayed differently, typically in a different color or position on all remote computers. The developer is also provided with the ability to allow the user to control any function or process that a particular machine 202 or controller 204 can perform as if the user is physically present at the machine 202 or controller 204. That is, a developer may permit a remote user to have the same ability as if the user were standing in front of the machine 202 or controller 204. For example, the user may press the “stop” button 314 in order to stop the stamping press, the button 314 will depress and illuminate. Other such controls (not shown) include the ability to increase or decrease the speed in which the stamping process is performed in real time.

The design mode for the HMI of the present invention provides flexibility to the HMI developer to design a custom application for the specific control requirements of each machine in the process to be controlled or monitored. For instance, a developer may make use of a user's network privileges in determining access rights for modifying a certain HMI application. For example, the HMI developer may restrict a user's rights to view only access of the HMI, while prohibiting control (actuation of any of the input tools such as pushbuttons, numeric entry displays, slide controls, etc). Likewise, the HMI developer may restrict application development to only specific users. Similarly, the HMI developer may limit access to a particular HMI by requiring a user to enter a password to access a particular HMI application.

The HMI developer can remotely edit or modify an existing HMI application. As discussed in further detail below, user actions, whether related to machine control or updating the HMI application, are transmitted through the system in real time (e.g., pushed, or automatically delivered at prescribed intervals or on the occurrence of an event), so that all users quickly have access to the same data and latest version of the HMI application. Similarly, machine control commands are push delivered to the controller 204 and ultimately to the machine 202 in real time.

In addition to the design mode, another aspect of the present invention is to provide a run-time mode. During the run-time mode, a user accesses the HMI application through a web browser 214. The web browser 214 includes a suitable interpreter, such as the Flash player 216 plug-in distributed by Macromedia, Inc. In addition, the web browser includes an input command tool 266. The input command tool receives information from the input device 266 and packages the input into a format that can be used by the server 220. It will be appreciated by one of ordinary skill in the art that such packaging includes appending the appropriate header and trailer frames as well as embedding the user input information via an appropriate protocol, if required.

With the web browser 214, the user is able to take full advantage of the capabilities provided by the HMI. That is, with the web browser 214, an operator may monitor and control all parameters specified by the HMI. For example, in the stamping press application discussed above in relation to FIG. 4, the user has the ability to monitor speed 306, pressure 308 and temperature 310 of the stamping press through the animation. The user also has the ability to stop the process by pressing the stop button 314. Note, as will be explained below in detail, all control functions that are modified by the user will be push delivered through the server 220 and transmitted to the machine 202 to effectively control the machine 202. Control functions that are modified by the user will also be pushed delivered to any other computers (e.g., computers 208B and 208C) to update the HMI panel(s) displayed at those locations. Thus, a user with adequate network security clearance will be able to remotely monitor and control the machine 202 just as if the user were physically located near the machine 202.

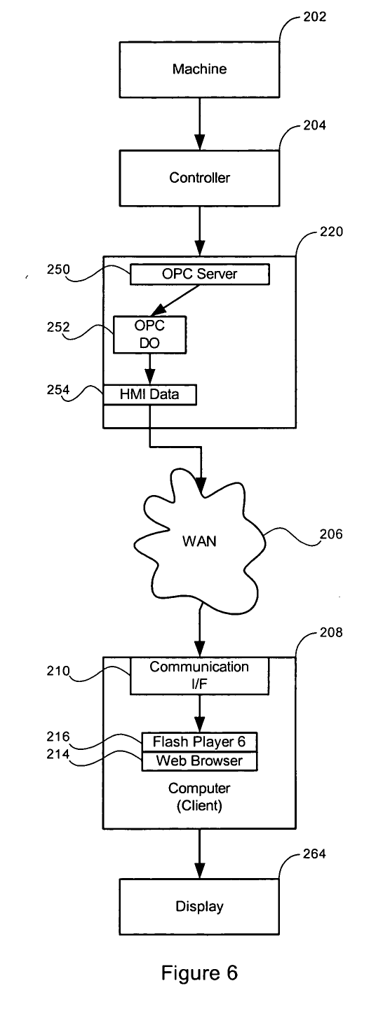

Having thus described the system, the flow of information throughout the system will now be specifically addressed. Turning to FIG. 6, shown is an example data path for machine information to be displayed to a user. For purposes of this data path, it is assumed that computer 208 is communicating with the server 220 where an animation appropriate for the machine is hosted. The computer 208 displays the animation as interpreted by the Flash player 216.

At predetermined times, when commanded or upon the occurrence of an event, machine 202 conveys certain information relating to physical parameters to the controller 204. The controller 204 transmits this information to the server 220. In particular, the information is received by the OLE for Process Control (“OPC”) server module 250. OPC is a software standard designed to provide industrial and commercial applications with convenient and common access to building and industrial plant floor data. Traditionally, each software or application developer was required to write a custom interface, or server/driver, to exchange data with hardware field devices. OPC eliminated this requirement by defining a common, high performance interface that permits this work to be done once, and then easily reused by HMI, SCADA, control and custom applications. While the present invention makes use of an OPC server module 250, one of ordinary skill in the art will readily appreciate that any communications driver or set of communication drivers that may be utilized for the functionality described herein may be used or substituted for the OPC server module 250.

The OPC server module 250, which includes a set of drivers for various controllers, routes the data to an OPC data object 252. The OPC data object 252 then routes the data to HMI data module 254. The HMI data module 254 uses a TCP/IP socket to exchange data in real time with the computer 208. The primary functions of HMI data module 254 are to provide updates to the clients (computer 208) from the various dynamic data objects (i.e., monitor and control variables that are used by the HMI application) and to update the dynamic data objects based on changes the clients push delivered to the server. As used herein, the terms “push delivery” and “push delivered” relate to the transmission of data or information, such as in the form of a data packet, in real time or near real time and such transmission being made without prior receipt of a request for an update.

As shown in FIG. 6, from the HMI data module 254, the data is sent through the WAN 206 and received at communications interface 210 of the computer 208. The data received by HMI data module 254 is then routed to the interpreter (e.g., Flash player 216) that interprets the received information and triggers a change in an assigned property of a corresponding graphical object contained within the animation being displayed. Since the graphical object corresponds to a physical parameter of the machine about which information was received at the browser 214, current machine parameters can be shown on the display 264.

Such graphical objects suitably comprise representations of physical controls on the machine 202. Once a change in an assigned property is rendered, the graphical object's visual appearance differs from its original appearance, thus reflecting a change in an aspect or part of machine 202 or the control thereof. Thus, the flow of information from machine 202 to user by way of computer 208 is complete.

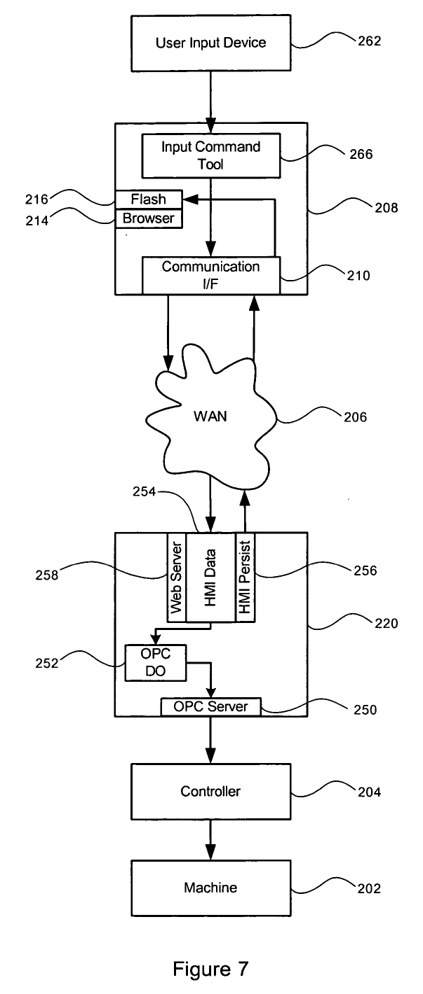

The present invention also provides information flow from computer 208 to machine 202. As shown in FIG. 7, the computer 208 includes an input command tool 266 that can receive a user input associated with a displayed graphical object corresponding to at least one controllable part of machine 202. Such a user input may be received via an input device 262 as will be appreciated by those of ordinary skill in the art.

The input command tool 266 interprets the user input and triggers a change in the assigned property command for the graphical object associated with the user input. The command is transmitted to the server 220 via communications interface 210 and WAN 206. The HMI data module 254 routes a command back upstream to the machine 202 to control the machine 202 via OPC data object 252, OPC server 250 and controller 204 in order to effectuate control of the machine 202. The HMI data module 254 also triggers a change in the assigned property of the corresponding graphical object to update the HMI panel or each computer 208 in the manner discussed above for updating the animation.

The HMI persist module 256 is utilized for a variety of functions including: loading a given XML code to allow a user interface to be dynamically created; identifying and listing which panels exist on a given device; identifying and listing which visual styles exist on a given device for each tool; and saving updates to the general configuration of the device. In addition, the HMI persist module 256 also provides a TCP/IP socket interface between the Flash player 216 of the computer 208 and the server 220. Another aspect of the HMI persist module 256 is to support the HMI data module 254 by allowing information defined by the user of the computer 208 to be stored on the server just as if the user was locally connected to the server. For instance, if the user adds an additional tool, graphic object or an HMI panel, or changes a control parameter, the HMI persist module 256 allows these changes to be saved directly on the server 220.

As indicated above, the HMI solution described herein also includes a design mode using a design component 212, which can suitably include the use of Flash MX. As previously stated, Flash MX provides only basic communication with the Flash animation from the page that the animation is hosted. In order to overcome this deficiency, a method of user scripting from a web browser 214 is implemented. The Flash player permits a user to communicate via two function calls: SetVariable(name, value) and GetVariable(name). Using these two functions, a user can utilize scripting to edit or modify an object associated with a Flash animation. For example, if a designer desired to create a new “button” in a particular HMI, the following script is written:
var button=Panel.CreatePart(“Button”);
   the script is then packaged as follows using the SetVariable function:
LittleRock.SetVariable(“HMI.ScriptEngine.Panel.Command”, CreatePart|Button”);
return LittleRock.GetVariable(“HMI.ScriptEngine.Panel.Result”);
   (where “LittleRock” refers to an example HMI application filename). Inside the Flash animation, code written in Actionscript monitors the HMI.ScriptEngine.Panel.Command variable for changes. When a change is detected, the text is parsed and the appropriate ActionScript code is processed. In the present example, a button would be displayed on the web browser. This method also permits the HMI designer to make function calls that require values to be returned. In such cases, the result is placed in the HMI.ScriptEngine.Panel.Result function call and returned for use to the web page. Thus, an efficient and robust system and method for implementing an HMI capable of real time transfer of data over the Internet is hereby disclosed.

Also, for any aspect of the HMI solution described herein, the code can be embodied in any computer-readable medium for use by or in connection with an instruction execution system such as, for example, a processor in a computer system or other system. In this sense, the logic may comprise, for example, statements including instructions or declarations that can be fetched from the computer-readable medium and executed by the instruction logic system. A “computer-readable medium” can be any medium that can contain, store or maintain the logic described herein or use by or in connection with the instruction execution system. A computer-readable medium can comprise any one of many physical media such as, for example, electronic, magnetic, optical, electromagnetic or semiconductor media.

It will be appreciated by persons of ordinary skill in the art that numerous variations and/or modifications may be made to the invention as shown in the specific embodiments without departing from the spirit or scope of the invention as broadly described. The present embodiments are, therefore, to be considered in all respects as illustrative and not restrictive. Such other features, aspects, and expected variations and modifications of the examples are clearly within the scope of the invention where the invention is limited solely by the scope of the following claims.

1. A system for providing a graphical human-machine interface for a machine having a controllable part, the system comprising:
a controller communicatively coupled to an associated machine having a controllable part;
a server communicatively coupled to the controller to receive information relating to properties of the associated machine;
at least one client communicatively coupled to the server; wherein the client includes a display and a web browser for displaying information on the display; wherein the server transmits a predetermined animation of the properties of the machine to the client, the predetermined animation including real time information relating to the properties, the real time information being introduced into the animation by a data module executed by the server that updates data object values in the animation.

2. The system according to claim 1 wherein the server is integral to the controller.

3. The system according to claim 1 wherein the server is communicatively coupled to the controller through a network.

4. The system according to claim 1 wherein the client is communicatively coupled to the controller through a network.

5. The system according to claim 1 wherein the real time information further includes a signal received from the client and associated with a user input intended to control at least one property of the machine.

6. The system according to claim 5 wherein the server issues a command corresponding to the user input to the controller to invoke control of the controllable part of the machine.

7. The system according to claim 1 wherein the browser includes an interpreter for interpreting the predetermined animation.

8. A method for providing a graphical human-machine interface for a machine having a plurality of controllable parts, the method comprising:
communicatively coupling a server to a controller of an associated machine having a controllable part to receive information relative to the properties of the associated machine;
communicatively coupling at least one client to the server; wherein the client includes a display and a web browser for displaying information on the display; and
transmitting a predetermined animation of the properties of the associated machine from the server to the client, the predetermined animation including real time information relating to the properties, the real time information being introduced in to the animation by a data module executed by the server that updates data object values in the animation.

9. The method according to claim 8 wherein the controller is communicatively coupled to the server through a network.

10. The method according to claim 8 wherein the client is communicatively coupled to the server through a network.

11. The method according to claim 8 further comprising receiving a control input from the client, transmitting a command corresponding to the control input to the server and updating a data object value in the animation that corresponds to the control input.

12. The method according to claim 11 further comprising issuing a command to the server corresponding to the control input to the controller to invoke control of the controllable part of the machine.

13. A method for providing a graphical human-machine interface for a machine having a controllable part, the method comprising:
requesting access to a web page from a server containing a human-machine interface for the machine for display on a display associated with a client;
receiving a predetermined animation of properties of the associated machine, the predetermined animation including real time information relating to the properties and rendering the predetermined animation;
receiving a user input to modify at least one assigned property of the predetermined animation;
re-rendering a graphical object associated with the modified property; and
communicating the modification to the server.

14. A method of providing a graphical human-machine interface for a machine having a controllable part, comprising:
receiving and rendering for display a predefined animation containing graphical objects from a server, each graphical object having an assigned property value and is associated with a property of the machine;
receiving a push delivered change to at least one assigned property value corresponding to a change in property of the machine and re-rendering a graphical object associated with the changed property value to update to the animation;
receiving a signal associated with a user action from a user input device; and
transmitting a command corresponding to the signal from the user input device to the server.

15. The method according to claim 14, further comprising receiving a push delivered change to at least one assigned property value corresponding to the signal from the input device and re-rendering a graphical object associated with the changed property value to update to the animation.

16. A method for providing a graphical human-machine interface for a machine having a controllable part, comprising:
receiving a request from a client for access to a web page with the graphical human-machine interface for the machine, the web page including a predetermined animation of properties of the associated machine;
transmitting the web page to the client; and
updating the predetermined animation to include real time information relating to the properties, the real time information being introduced in to the animation by a data module executed by the server that transmits updated data object values for graphical objects of the animation to the client.

17. The method according to claim 16, further comprising receiving a signal from the client corresponding to a user action intended to invoke control of the controllable part of the machine.

18. The method according to claim 17, further comprising updating the predetermined animation to include a change corresponding to the user action by transmitting an updated data object value for a corresponding graphical object of the animation to the client from the data module executed by the server.

19. The method according to claim 17, further comprising sending a command from the server to a controller associated with the machine, the command corresponding to the user action to thereby invoke control of the controllable part of the machine.

20. A method of changing an object value in a predefined animation, comprising:
transmitting the predefined animation to an interpreter for rendering, the predefined animation containing graphical objects each with an assigned property value;
receiving a signal containing information relating to an update for one of the graphical objects; and
push delivering a new property value for the one of the graphical objects to the interpreter for re-rendering the one of the graphical objects.

21. The method according to claim 20 wherein the received signal is transmitted by a client executing the interpreter in response to a user input action associated with the one of the graphical objects.

22. The method according to claim 20 wherein the received signal is transmitted in response to a change in a property of a machine.

23. A method of changing an object value in a predefined animation, comprising:
receiving the predefined animation from a server and rendering the predefined animation with an interpreter executed by a client, the predefined animation containing graphical objects each with an assigned property value; and
receiving a push delivered new property value for the one of the graphical objects with the interpreter and re-rendering the one of the graphical objects.

24. The method according to claim 23 wherein the push delivered new property value is transmitted by the server.

25. The method according to claim 23 wherein the push delivered new property value is generated locally by the client.

26. The method according to claim 23 wherein the push delivered new property value is generated in response to a signal containing information relating to an update for one of the graphical objects.

27. The method according to claim 26 wherein the received signal corresponds to a user input action associated with the one of the graphical objects.

28. The method according to claim 26 wherein the received signal is transmitted to the client by the server in response to a change in a property of a machine.
